(19) United States
(12) Patent Application Publication
(10) Pub. No.: US 2010/0038913 A1
(43) Pub. Date: Feb. 18, 2010

(54) DEVICE FOR UTILIZING OCEAN-WAVE ENERGY

(76) Inventor: Ernst Johnny Svelund, Tustna (NO)

Correspondence Address: WENDEROTH, LIND & PONACK, L.L.P., 1030 15th Street, N.W.,, Suite 400 East, Washington, DC, 20005-1503, US

(21) Appl. No.: 12/524,629

(22) PCT Filed: Jan. 24, 2008
(86) PCT No.: PCT/NO2008/000024

§ 371 Date: Oct. 21, 2009

(30) Foreign Application Priority Data
Jan. 30, 2007 (NO) 20070574

(51) Int. Cl. F03B 13/20; B63B 21/00; B63B 21/50; G05D 9/12; G06F 19/00

(52) U.S. Cl. 290/53; 114/230.12; 114/293; 700/281; 700/287

(57) ABSTRACT

According to the invention, the device for utilising ocean-wave energy functions through appropriate pontoons (1) and an intermediate floating central unit (2) located just beyond them. These are interconnected by appropriate arms (3) using suitable hinges (4) and have suitable cylindrical, hydraulic power jacks (7) which alternately pump a liquid (10) under high static pressure to a turbine (11), preferably a constant pressure (Pelton) turbine. This converts the potential energy in the liquid into, for example, electric power when the arms are raised by the pontoons and the central unit sinks into the wave troughs, whereupon the pistons (12) on the opposite side of the power jacks again suck in the continually circulating, energy-bearing liquid as the arms sink when the pontoons enter the troughs and the central unit rises on the wave crests.

The present invention concerns a device to convert the energy in ocean waves into useful energy in an efficient and reliable manner.

The existing technical solutions for utilising ocean-wave energy are poorly cost-efficient as regards operation, manufacture and completion.

Two Norwegian engineers, J. and K. Budal Falsen, published a proposal in the 1970s for a system of anchored, cylindrical pontoons to oscillate with the waves and take up energy from the oscillating water masses. These pontoons were to be equipped with a hydraulic piston which was fixed to the seabed. The piston would operate an electric generator from which the energy would be fed to land by an electroconductive cable. The greatest shortcoming with this system was the need to continually adjust the buoys and the mooring to the seabed, which might be a complicated and expensive process, particularly in relatively deep water.

Another device that may be mentioned is a floating buoy invented by S. H. Salter at the University of Edinburgh. Here, the re-administration of the energy takes place by the buoys pivoting up and down about a central axis when the waves pass. The rotational energy released here is transformed into electric power via a generator, either directly or indirectly via a controlling and rectifier process. A drawback here is the necessity for a large, heavy, equilibrium float which may be as long as 300 metres, i.e. as long as a supertanker, and which should really not be able to be affected by the waves. The device, moreover, is not constructed in such a way that it is self-regulatory with respect to changes in the wave direction.

These drawbacks can be avoided with the present invention. The technical solutions on which this invention is based result in optimal cost-effectiveness, irrespective of the size of the plant, which may be relatively small, such as 20 kW, or up to, say, 100 MW. A plant with an output of around 0.6 MW will measure approximately 25×25 m and one producing 108 MW might consist of 36 units, each of which measures 25×110 m, arranged in a square where the individual units are spaced 200-300 m from each other and are linked together by a common, stationary network of anchors just beneath them.

The invention can be employed to generate electric power that can be conveyed to land by an electroconductive cable, or the converted wave energy can, for example, be used to produce hydrogen from the seawater by electrolysis for conveyance to land by pipeline or vessel.

According to the invention, this is achieved by having suitable pontoons located a short distance from an intermediate, floating central unit in such a way that the pontoons and the central unit are linked to one another by suitable lever arms which are attached to the pontoons and the central unit by appropriate hinges. This enables the pontoons and the central unit to rise and sink vertically relative to the wave are linked to one another by suitable lever arms which are attached to the pontoons and the central unit by appropriate hinges. This enables the pontoons and the central unit to rise and sink vertically relative to the wave movement in the sea. Appropriate cylindrical, hydraulic power jacks which, together, constitute a power unit, are located above the central unit and attached directly to and between each arm. These jacks alternately pump a liquid under high static pressure. A turbine, preferably a Pelton turbine (a constant pressure turbine), then converts the potential energy in the liquid into, for example, electrical energy, when the arms are raised by the pontoons and the central unit is depressed between the waves. The constantly circulating, energy-bearing liquid is then sucked into the hydraulic power jacks on the opposite side of the jack pistons when the arms sink as the pontoons descend into the wave troughs and the central unit is simultaneously lifted on the wave crests. A girder can be attached to one of the central units between two other central units that are hinged to one another in such a way that each of them is vertically flexible (pliable) relative to the other, and this girder is further attached to a floating processing lighter where the potential energy in the liquid from the power jacks is converted into another form of energy. A specially designed, rotatable mooring and energy-transmitting device is attached to the lighter at the opposite end from where the girder is attached, and this ensures that the device for utilising the wave-power energy automatically (self-regulatorily) places itself head on to the wind and the waves.

In the following, the invention is described in more detail with the help of examples and figures where:

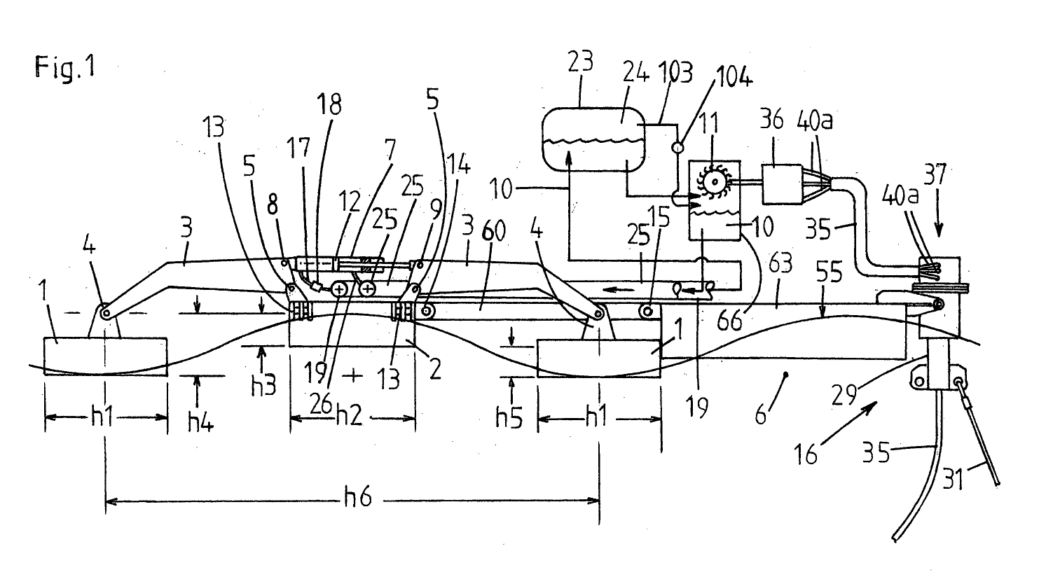

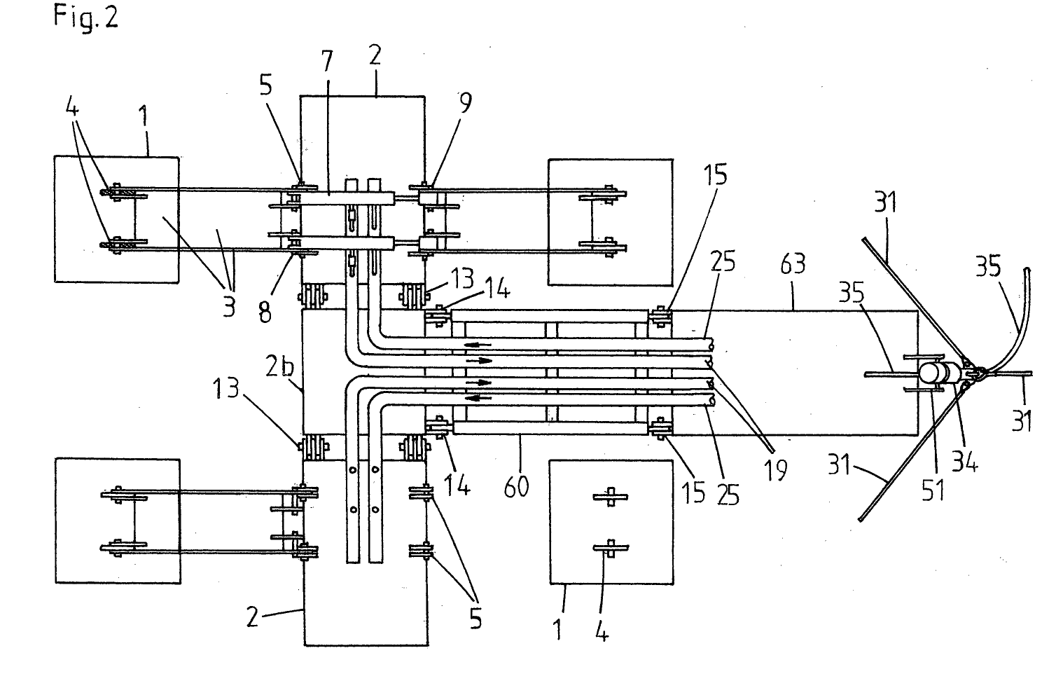

FIGS. 1 and 2 illustrate the existing device viewed from the side and above, respectively

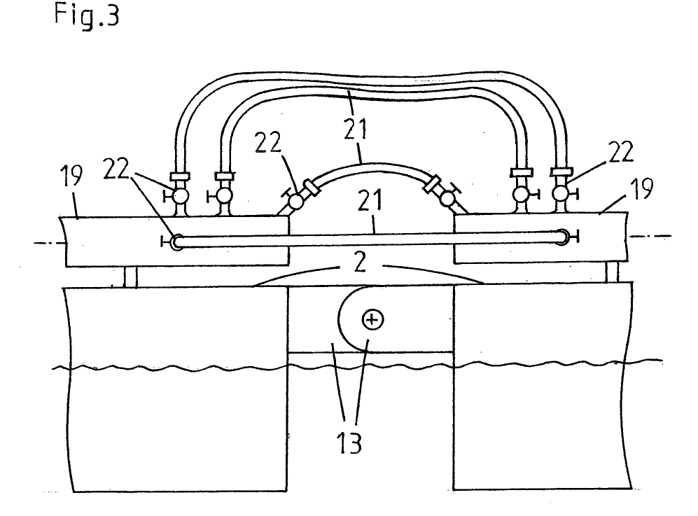

FIG. 3 shows how the central units of two power units are hinged together

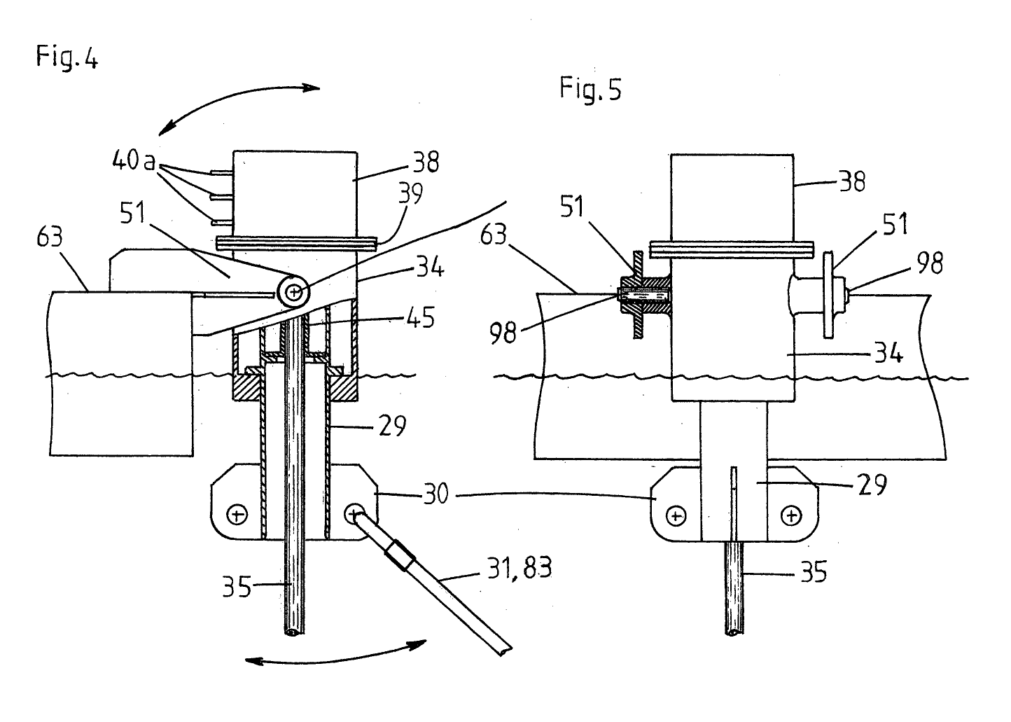

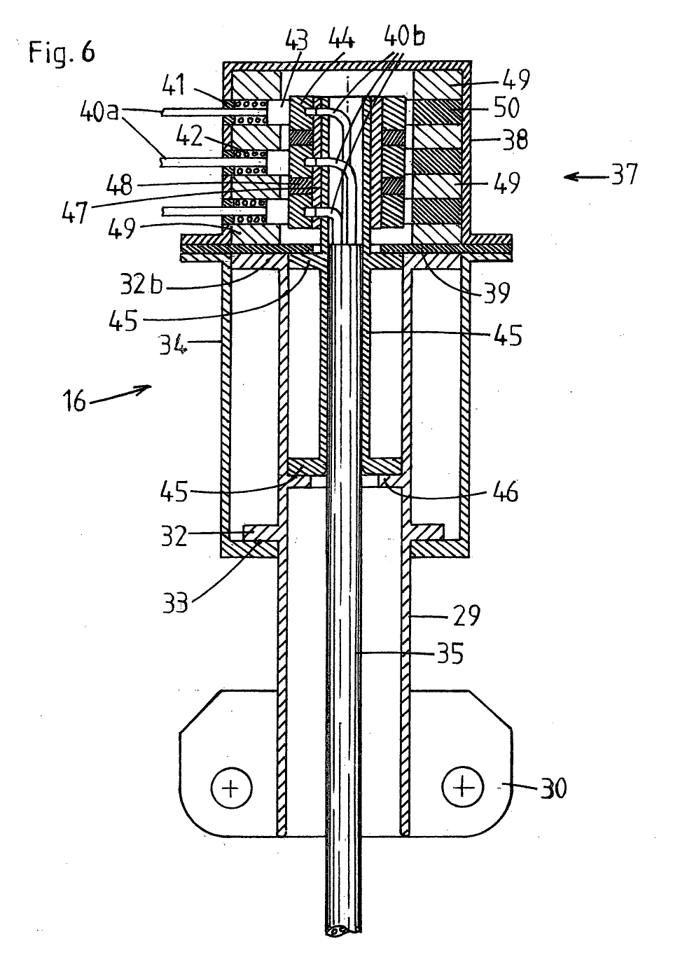

FIGS. 4, 5 and 6 show how the rotatable mooring and energy-transmitting device is constructed and is attached to the floating lighter connected to a central unit via a girder, where the energy from the wave-power device is converted into another type of energy

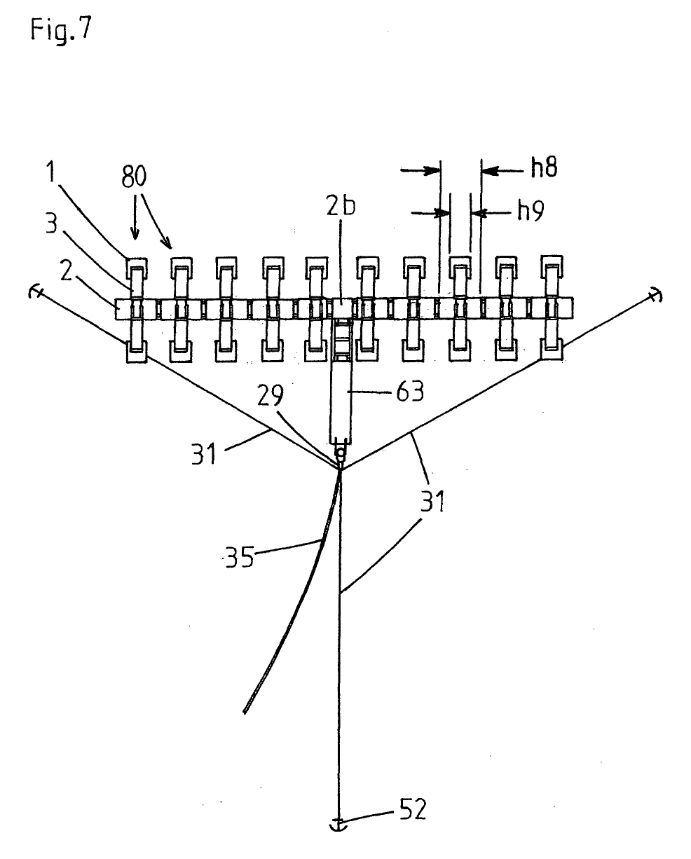

FIG. 7 shows how several power units can be fitted together into a larger unit with a common processing lighter

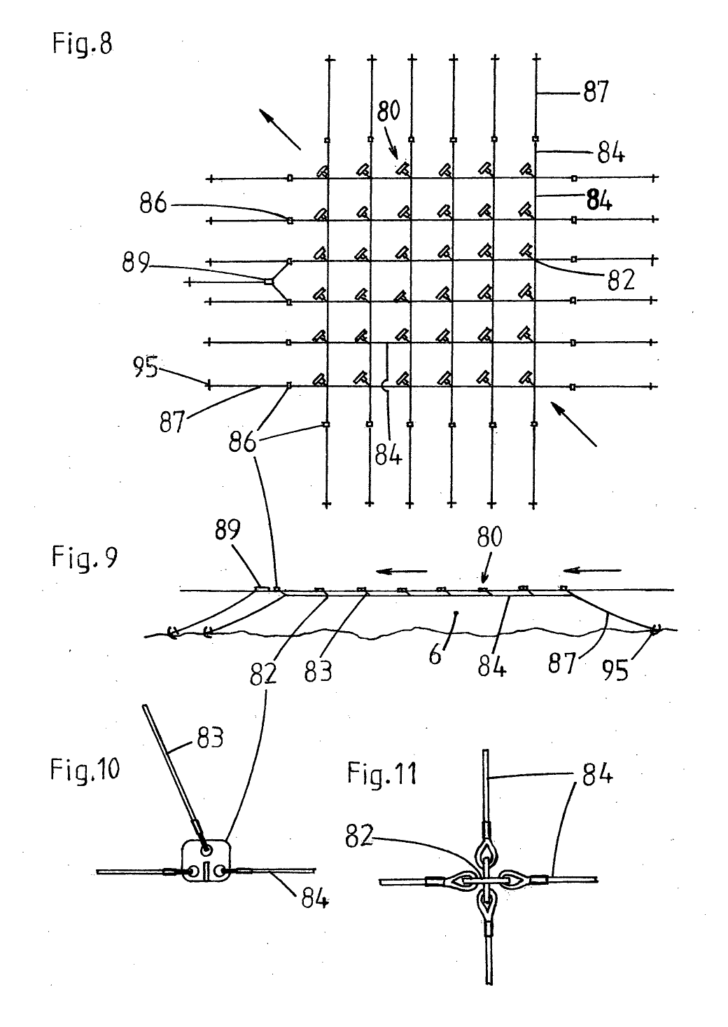

FIGS. 8 and 9 show how several large power units can be attached to a common mooring net where the energy from each unit is fed to a common processing unit moored close to the plant. The wind direction here is shown by arrows.

FIGS. 10 and 11 illustrate how each power unit can be connected to the mooring net with the help of lines fixed to contraptions on the net, which is situated a few metres below the surface, beneath the power units.

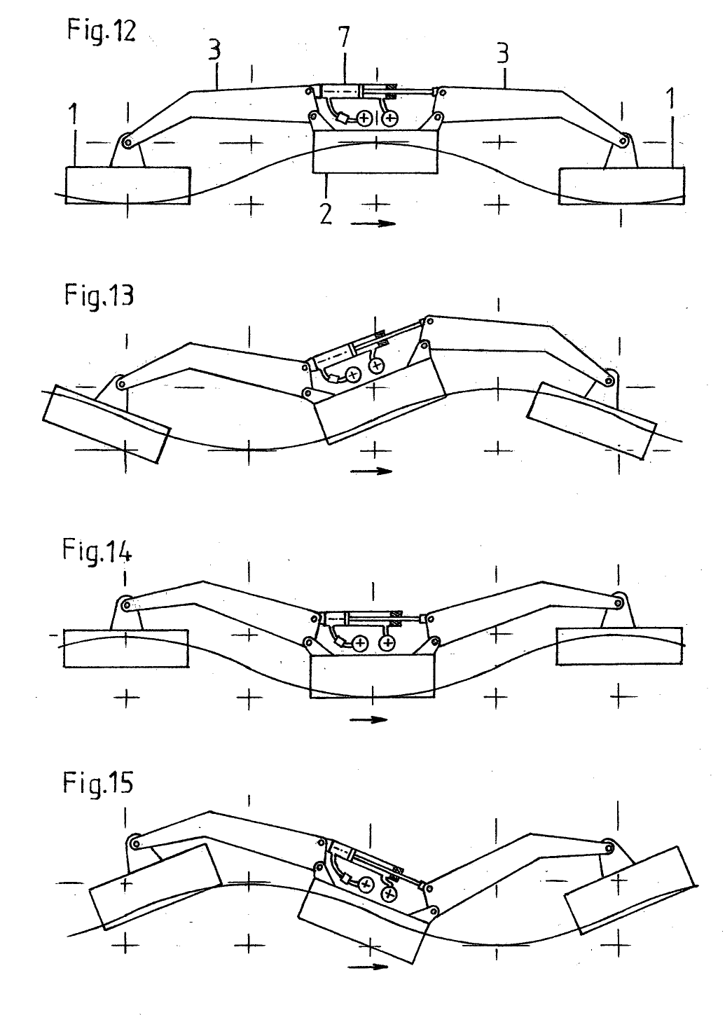

FIGS. 12, 13, 14 and 15 illustrate different stages in the process. From FIG. 12 to 13, the pontoons are pressed down in the sea at the same time as the central unit(s) rise(s). FIGS. 13 to 14 show the power jacks being pressed together. From FIG. 14 to 15, the pontoons are lifted up again at the same time as the central unit(s) sink(s) into the sea. From FIG. 15 to 12, the central unit is raised by a wave crest whose height is ½·h4 (h4 denotes the wave height), while the pontoons sink an equal amount at the same time as liquid is sucked into the power jacks again before the whole process is repeated. The time this takes is ¼·T, corresponding to the “pace”. The arrows in FIGS. 12-15 denote the wind direction.

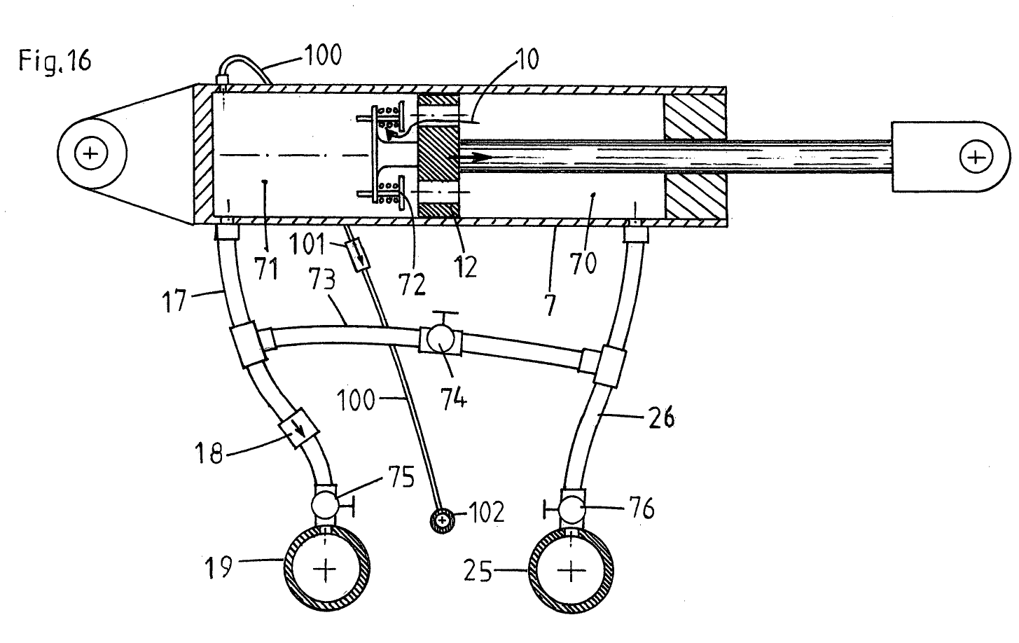

FIG. 16 shows how the power jacks are attached to the pipes that convey the continually circulating, energy-bearing liquid which converts the potential energy in the liquid to another type of energy.

Some measurements, h, are shown in FIG. 1, partly to describe the outputs that can be achieved.

The maximum output capacity can be expressed by the formula: W=m1·g·h4·Z·0.75, where
m1=the mass, in kg, of seawater which the pontoons displace as the power jacks are pressed together, minus the mass of the water the pontoons displace when they do not exert pressure against the power jacks. The pontoons begin to press the power jacks together when the water is raised ½·h4 up onto the pontoons, which at the same time corresponds to the “sinking” water level around the central unit(s).
g=the gravitational acceleration≈9.8 m/s² Z=wave frequency per second=1/T
T=time, in seconds, between wave crests=(h6/1.56)^{1/2} 0.75=correction due to various operational losses h6=the distance between wave crests, in metres, determined by the formula: T²·1.56 h4=wave height, in metres.

FIG. 1 shows pontoons 1 located just beyond an intermediate, floating central unit 2, which may consist of a tank with internal partitions filled with seawater, and these are interconnected by appropriate (lever) arms 3 attached using suitable hinges 4, 5, or perhaps intermediate girders (not shown) attached to the hinges 4, 5, to constitute a single power unit 80 that enables the pontoons 1 and the central unit 2 to rise and sink vertically relative to the waves 55 from the ocean 6. When the arms 3 are raised by the pontoons 1 and by the central unit 2 when it sinks between the waves 55, appropriate cylindrical, hydraulic power jacks 7 attached directly to and between each arm 3 using robust axles or hinges 8, 9 alternately pump, under high pressure, a liquid 10 such as water with glycol added via a turbine 11, preferably a Pelton turbine, to an electric generator 36 which converts the potential energy in the liquid 10 into, for example, electric power. The continually circulating energy-bearing liquid 10 is then sucked into the power jacks on the opposite side of their pistons 12 at the same time as it flows from the low-pressure 70 to the high-pressure zone 71 in the power jacks via back-flow check valves 72 placed in the pistons 12. This process is repeated when the arms sink as the pontoons 1 descend into the wave troughs while the central unit 2 is simultaneously raised on the wave crests.

FIG. 1 also shows how the various components of the power units 80 are to be dimensioned. The widths, h1 and h2, of the pontoons 1 and the central unit 2, respectively, are approximately ¼ of the estimated average wave length, h6, which corresponds to the distance between the hinge fasteners 4 of the arms 3 placed centrally on the pontoons 1. The buoyancy peak, h5, of the pontoons, before they begin to press the power jacks 7 together, and the draught, h3, of the central unit 2 are approximately ½ of the estimated average wave height, h4, before the power jacks 7 are pressed together, whereas the length:width ratio, h8, of the central unit(s) 2 to two of the pontoons 1 on either side of the central unit(s) is twice as large as the length:width ratio, h9, of the pontoons 1, so that the central unit(s) 2 is/are raised to the same height as the buoyancy peak, h5, of the pontoons when these attain their maximum lifting capacity as they are raised by the water 6.

FIG. 2 shows how several power units 80 can be interlocked using appropriate hinges 13, or perhaps intermediate girders (not shown) which pass over the central units 2, 2b and are attached to their upper part. The middle central unit 2b is attached to a girder 60 which is hinged 14 to the central unit 2b and hinged 15 to a floating lighter 63 where the potential energy in the liquid 10 from the power jacks 7 is converted into another type of energy. FIG. 2 also shows that a specially designed, rotatable mooring and energy-transmitting device 16 is attached to the lighter 63 on the opposite end to where the girder 60 is placed, and this ensures that the power unit or units 80 automatically head(s) into the wind and the ocean waves 55.

FIG. 3 shows how the energy-bearing, continually circulating liquid 10 is conveyed from the power jacks 7 via some flexible high-pressure hoses 17 equipped with appropriate back-flow check valves 18 which are attached to robust high-pressure pipes 19 placed on each of the central units 2, the girder 60 and the lighter 63. Appropriate opening and closing valves 75 are placed at the entrances to these high-pressure pipes 19, and the liquid is conveyed between each of the central units 2 through appropriate, flexible, high-pressure hoses 21. Appropriate opening and closing valves 22 are attached directly to the high-pressure pipes 19 at the entrances and exits of these high-pressure hoses 21. The liquid is thereafter conveyed to a pressure-balancing tank 23 that is partly filled with a gas 24, such as air, which is fed into the tank 23 as required, and a valve attached to the tank 23 releases air into the atmosphere as required. The liquid 10 then continues to the turbine 11, placed high on the floating lighter 63, where a mechanism controls the volume of the liquid 10 flowing through it. From the turbine, the liquid 10 is conveyed back to the power jacks 7 through appropriate, perhaps flexible, return pipes 25 with flexible pipes between the central units 2, in the same way as it is conveyed from the power jacks 7 to the turbine 11, and through flexible return hoses 26 from the return pipes 25 and the power jacks 7 that are equipped with opening and closing valves 76. Appropriate shunt hoses 73 or pipes 73 equipped with shunt opening and closing valves 74 are placed between these flexible return hoses 26 and the flexible high-pressure hoses 17 (placed, for example, on top of the power jacks) and between the power jacks 7 and the back-flow check valves 18. A return bleeder 100 placed in the base and on the upper side of the power jacks 7 leads to the gas zone above the water level inside the recirculation tank 66 beneath the turbine wheel 11 via a common bleeder return pipe 102 where appropriate back-flow check valves 101 are provided for each return bleeder 100 from the power jacks 7. A pipe connection 103 is placed in the gas zone 24 inside the pressure-balancing tanks 23 and to the gas zone beyond the turbine wheel 11, and this is equipped with an appropriate valve 104 to regulate any gas supply from the gas zone 24 inside the pressure-balancing tanks 23 to the gas zone beyond the turbine wheel 11. These contrivances are essential because some air which will be mixed with the water when it is carried over the turbine blades will accompany the continually circulating water during the flow process.

FIGS. 4, 5 and 6 show how the rotatable mooring and energy-transmitting device 16 is constructed. It comprises a cylindrical, rotatable mooring unit 29 equipped with external fasteners 30 to which the lower ends of the anchor lines 31, which consist of a robust alloy, wire or chains, are fastened where a receptacle 32 fixed to their outer side fits into a matching receptacle 33 placed on the lower part of an external, cylindrical, non-rotatable mooring base 34. The mooring unit fits into the base via a neckline 32b that abuts against the base 34 which, in turn, is hinged to the lighter 63 by two axles 98 that are part of a hinge contraption 51 fastened to the lighter 63 in such a way that the external fastening devices 30 and the mooring base 29 can pivot vertically up and down as the anchor lines 31 move, at the same time as the mooring unit 29 is capable of rotating relative to the mooring base 34. The electric power from the electric generator 36 is conveyed via an electroconductive cable 35 through the centre of the cylindrical, rotatable mooring unit 29, but passes first through a non-rotatable electric transmission unit 37 used to transmit electrical energy to and through the rotatable electroconductive cable on the inner side of the mooring unit 29. The non-rotatable unit 37 consists of an external protective cap 38 fixed to the mooring base 34 with the help of, for example, suitable bolts. An intermediate thrust plate 39 ensures that the rotatable mooring unit 29 and the electroconductive cable 35 do not press up into the non-rotatable electrical transmission unit 37. Each electroconductive phase 40a from the generator 36 is led into the external protective cap 38 via electrical insulators 41 fixed to the cap. Internal pressure springs 42 press appropriate stationary, electroconductive transmission units 43 made of, for example, carbon, against commutators 44 connected to the electroconductive phases 40b in the electroconductive cable 35 which continues via the mooring unit 29 and is enclosed in a robust cylindrical protective shield 45 which abuts against a receptacle 46 placed on the inner side of the mooring unit 29 and against part or all of the upper part of the cylindrical mooring unit 29 and against the thrust plate 39 before ending slightly above the phase conductors 40b which pass through holes in the shield 45. A cylindrical insulator 47 is located against the upper part of the shield 45 and on the inner side of the commutators 44, and additional insulators (48) are placed between the commutators 44. Further insulators 49 are located between the stationary electroconductive transmission units 43 and insulators 50 on the outer side of the commutators 44 and against the stationary electroconductive transmission units 43.

FIG. 7 shows how the rotatable mooring and energy-transmitting device 16 is attached to at least three anchor lines 31 which, in turn, are attached to appropriate weights 52, for example anchors 52, distributed around and away from the rotatable mooring and energy-transmitting device 16.

FIGS. 8-10 show how several power units 80 are attached to a submarine mooring net consisting of robust connecting devices 82 to which each power unit 80 is linked by connecting lines 83—up to four lines 83 to separate connecting devices attached to the mooring net outside the middle connecting device 82 to which the lines 83 in this case are not attached—and to the fastening arrangements 30 of the mooring and energy-transmitting device 16, each connecting device 82 being kept in place by four intermediate connecting lines 84 which lie horizontally beneath the surface of the sea and pass at approximately 90° to each other out from the connecting device 82. The connecting device 82 outside the outermost of the power units 80 is connected to appropriate buoyancy buoys 86 via connecting lines 83 which are attached to the buoys on the surface, and appropriate anchor lines 87 fastened to a weight 95, or an anchor 95, on the seabed, run out from these outermost connecting devices 82. Cables 35 carrying electric current run from each of the power units 80 to a moored, floating, processing lighter 89 which may also be moored to some of the buoyancy buoys 86 just beyond the plant. The electrical energy is collected here and is transmitted to land by cable or used here to produce, for example, hydrogen, methanol or ethanol from seawater by electrolysis. These products may then be conveyed to land in pipelines or suitable vessels for further processing.

The electric power which is produced on the floating lighters 63 or the processing lighter 89 can be conveyed directly or indirectly to a controlling or rectifier process. The power production on the installations can be monitored and regulated from an external location, for example on land, via satellites or other appropriate communication systems.

The work process concerning the turbine and generator plant takes place as follows:

The medium (water) is put under pressure from the wave-absorption plant and is conveyed from there to the turbine plant, initially via one or more pressure-balancing tanks 23, before it is returned (recirculated) to the wave-absorption plant for replenishment of new potential energy, via a recirculation tank 66.

The pressurised water from the wave-absorption plant flows to the turbine with little variation in pressure. The maximum working pressure during the flow is fixed at 55 bars (+atmospheric pressure). During the flow, the pressure in the water from the wave-absorption plant will vary between 55 and 51.5 bars. In a matter of 0.9 seconds, it will rise from 51.5 to 55 bars before dropping from 55 bars to 51.5 bars in the succeeding 2.7 seconds before the process is repeated. During this variation in pressure, the level, h11, within the pressure-balancing tanks 23 will vary by about 0.19 metres, depending partly on the total volume inside them. At the same time, a corresponding variation in pressure will take place in the recirculation tanks 66, but there the pressure will be reduced by about 0.15 bars when the pressure in the pressure-balancing tanks 23 increases by 3.5 bars. The total variation in pressure before and after passing the turbine will therefore be approximately 3.65 bars, i.e. about 7.3% compared with the difference in pressure of 55-5 bars before and after the turbine (somewhat less at normal output—3 MW and lower, i.e. 2.92 bars, which is 5.84%).

Because of the variations in pressure in the pressure-balancing tanks 23, the phase boundary between the water surface and the air there varies by h10≈0.239 metres within the same time intervals, 0.9 and 2.7 seconds.

When the pressure in the pressure-balancing tanks 23 is 55 bars, the pressure in the recirculation tanks 66, 67 will be 4.85 bars. When the pressure in the pressure-balancing tanks is 51.5 bars, the pressure in the recirculation tanks will be 5 bars.

The maximum pressure, 55 bars, in the pressure-balancing tanks 23 remains constant even though the output, which is determined by the amount of water from the wave-absorption plant, is reduced to about 3 MW, which represents the mean output of the plant when the wave height is approximately 2.5 metres. This is the mean wave height off the coast of Norway.

When the output is between 3 and 4 MW, the water levels in the tanks 23, 66 will be at specific positions. These water levels must always be within these limits. When the wave height decreases, the water in the pressure-balancing tanks 23 sinks, whereas that in the recirculation tanks 66 will rise. When the water moves within these specific limits, it should not be necessary to regulate the flow area of the “regulating needles” using the nozzle(s) which direct the water jet towards the turbine wheel.

The regulating needle only operates when the output is between 3 and 4 MW because the water pressure, 55 bars, within this range of output should remain unchanged so that the water velocity, up to 100 m/s, from the turbine nozzle should be held constant. This is achieved when the flow area here varies proportionally with the variation in output between 3 and 4 MW, i.e. when the volume of water through the turbine nozzle varies between about 750 and 1000 kg per second.

When the water level in the pressure-balancing tanks 23 has reached its highest position a sensor 64 will ensure that air is released from the pressure-balancing tanks 23 if the wave heights decrease further, and this will stabilise the height of the water. The difference between the variation in the pressure of the water before and after passing the turbine, when the wave height decreases, will correspond to the reduction in the wave height (i.e. the average height).

When the wave height increases again, the pressure and the height of the water in the pressure-balancing tanks 23 will begin to rise again. If the waves were so reduced that it was necessary to release the air pressure in the pressure-balancing tanks 23, the pressure inside them will be lower than 55 bars when the water level returns to its highest position. A sensor here will in any case ensure that the water level does not rise above this position when the wave height increases further towards 2.5 m. This is achieved by feeding compressed air from a compressor into the tanks 23 again. Even if the waves rise higher than say 2.5 m, when the output increases from 3 MW the static pressure inside the tanks 23 should not exceed 55 bars.

Normally, the phase boundary between the water and the air in the recirculation tank(s) 66 is only set once, when the plant is started. Appropriate sensors 68, 69 ensure that the level when the plant starts is, for example, at the lowest level when the pressure in the pressure-balancing tanks 23 is 55 bars when the water there is at its highest level.

The plant is started by first filling the feed pipes 19, 25, pressure-balancing tanks 23 and recirculation tanks 66 with water. The water levels here must be either at the highest and lowest levels or the lowest and highest levels, respectively. Compressed air with a uniform pressure is then fed into the tanks 23, 66 until the pressure in all the tanks reaches 5 bars if the phase boundary between the water and the air inside the recirculation tanks 66 is at its lowest level, or 7.5 bars at its highest level. More compressed air is fed into the pressure-balancing tanks 23 when the wave-power device begins circulating the water in the plant so that the phase boundary between the water and the compressed air in the pressure-balancing tanks 23 is always between the highest and lowest permitted levels, as described above.

If the wave height becomes very low, when the water pressure in the water feed pipe 19 from the wave-power device becomes lower than in the recirculation tanks 66, the supply from the pressure-balancing tanks 23 to the turbine nozzle must be shut off so that the air pressure in the recirculation tanks 66 does not “blow” the water from these tanks via the return pipes 25. This shut off can be carried out with the regulation needle.

When the water inside the pressure-balancing tanks is at its highest level, the static pressure (+atmospheric pressure) inside the recirculation tank will be about 7.5 bars.

The pressure in the recirculation tanks 66 is intended to prevent possible cavitation arising when the wave-absorption plant sucks water from them. Owing to the pressure in the recirculation tanks, the turbine axle should or must exit into the atmospheric zone on both sides of the turbine housing so that the axial compressive forces that act on the turbine axle are equilibrated. Owing to the impulse variation in the medium (the water), the turbine wheel, for example, should perhaps have an extra centrifugal weight mounted or integrated if the weight of the turbine wheel and the rotating part of the electric generator is too small to equilibrate these impulse variations in a satisfactory manner.

An electrical rectifier ensures a constant electrical impulse frequency out of the plant when the speed of the turbine wheel, due to lower water pressure from the wave-absorption plant giving rise to lower velocity in the water issuing from the turbine nozzle, changes when the output is below about 3 MW.

A specially written computer program will monitor and manage the essential pressure and water levels inside the pressure-balancing 23 and recirculation tanks 66 and ensure that optimal output occurs under all wave conditions.

The optimal output can be found here with the regulation needle which, within specific time intervals such as every 15 minutes or hourly, increases and decreases the flow area somewhat via the turbine nozzle where the regulation needle is set to the best output recorded during these output measurements.

A computer program that processes signals from essential sensors placed inside the pressure-balancing 23 and recirculation tanks 66 ensures that the water levels in these tanks always remain within their permitted upper and lower limits. Any shortage of air in the recirculation tanks 66 is replenished with air taken from the air zone 24 in the pressure-balancing tanks 23 via a pipe or hose connection 103 equipped with an adjustable full-way valve 104 controlled by signals from the computer program. Any excess of air in the pressure-balancing tanks 23, which is recorded by a pressure sensor inside the tanks which is linked to the computer program, is led directly to the atmosphere via a valve controlled by the computer program and attached to a pipe leading into the gas zone 24 inside the pressure-balancing tank 23. An appropriate compressor which is directly or indirectly run from the turbine plant, and is controlled by the computer program, takes compressed air into the gas zone 24 via the same pipes when the maximum pressure in the gas zone 24 is not attained because the water level inside the pressure-balancing tanks 23 has reached its maximum permitted level in the tanks 23. Shunt pipe connections equipped with start-to-leak loaded back-flow check valves can be installed between the high-pressure 19 and low-pressure pipes 25.

1. A device for utilising ocean-wave energy, characterised by appropriate pontoons (1) located just beyond an intermediate, floating central unit (2) which can consist of a tank with internal partitions filled with seawater, these being interconnected by appropriate (lever) arms (3) attached using suitable hinges (4, 5), or perhaps intermediate girders attached to the hinges (4, 5), to constitute a single power unit (80) allowing the pontoons (1) and the central unit (2) to rise and sink vertically relative to the waves (55) from the ocean (6). When the arms (3) are raised by the pontoons (1) and by the central unit (2) when it sinks between the waves (55), appropriate cylindrical, hydraulic power jacks (7) attached directly to and between each arm (3) using robust axles or hinges (8, 9) alternately pump, under high pressure, a liquid (10) such as water with glycol added via a turbine (11), preferably a Pelton turbine, to an electric generator (36) which converts the potential energy in the liquid (10) into, for example, electric power, whereupon the continually circulating energy-bearing liquid (10) is sucked into the power jacks (7) on the opposite side of their pistons (12) at the same time as the liquid (10) flows from the low-pressure (70) to the high-pressure zone (71) in the power jacks via back-flow check valves (72) placed in the pistons (12), and the process is repeated when the arms sink as the pontoons (1) descend into the wave troughs while the central unit (2) is simultaneously raised on the wave crests.

2. According to claim 1, the device for utilising ocean-wave energy is characterised by the widths, (h1) and (h2), of the pontoons (1) and the central unit (2), respectively, being approximately ¼ of the estimated average wave length, (h6), which corresponds to the distance between the hinge fasteners (4) of the arms (3) placed centrally on the pontoons (1), where the buoyancy peak, (h5), of the pontoons, before they begin to press the power jacks (7) together, and the draught, (h3), of the central unit (2) are approximately ½ of the estimated average wave height, (h4), before the power jacks (7) are pressed together, whereas the length:width ratio, (h8), of the central unit(s) (2) to two of the pontoons (1) on either side of the central unit(s) is twice as large as the length:width ratio, (h9), of the pontoons (1), so that the central unit(s) (2) is/are raised to the sane height as the buoyancy peak, (h5), of the pontoons when these attain their maximum lifting capacity as they are raised by the water (6).

3. According to claim 1, the device for utilising ocean-wave energy is characterised by several power units (80) being capable of being interlinked using appropriate hinges (13), or perhaps intermediate girders which pass over the central units (2, 2b) and are attached to their upper part, where the middle central unit (2b) is attached to a girder (60) which is hinged (14) to the central unit (2b) and intermediate girders which pass over the central units (2, 2b) and are attached to their upper part, where the middle central unit (2b) is attached to a girder (60) which is hinged (14) to the central unit (2b) and hinged (15) to a floating lighter (63), and the potential energy in the liquid (10) from the power jacks (7) is converted into another type of energy, and a specially designed, rotatable mooring and energy-transmitting device (16) is attached to the lighter (63) on the opposite end to where the girder (60) is placed thus ensuring that the power unit(s) (80) automatically head(s) into the wind and the ocean waves (55).

4. According to claim 1, the device for utilising ocean-wave energy is characterised by the energy-bearing, continually circulating liquid (10) being conveyed from the power jacks (7) via some flexible high-pressure hoses (17) equipped with appropriate back-flow check valves (18) which are attached to robust high-pressure pipes (19) placed on each of the central units (2), the girder (60) and the lighter (63), appropriate opening and closing valves (75) being placed at the entrances to these high-pressure pipes (19), and the liquid being conveyed between each of the central units (2) through appropriate, flexible, high-pressure hoses (21); appropriate opening and closing valves (22) are furthermore attached directly to the high-pressure pipes (19) at the entrances and exits of these high-pressure hoses (21). The liquid is thereupon conveyed to a pressure-balancing tank (23) that is partly filled with a gas (24), such as air, which is fed into the tank (23) as required, and a valve attached to the tank (23) releases air into the atmosphere as required. The liquid (10) then continues to the turbine (11), placed high on the floating lighter (63), where a mechanism controls the volume of the liquid (10) flowing through it. From the turbine, the liquid (10) is conveyed back to the power jacks (7) through appropriate, perhaps flexible, return pipes (25) with flexible pipes between the central units (2), in the same way as it is conveyed from the power jacks (7) to the turbine (11), and through flexible return hoses (26) from the return pipes (25) and the power jacks (7) that are equipped with opening and closing valves (76). Appropriate shunt hoses (73) or pipes (73) equipped with shunt opening and closing valves (74) are placed between these flexible return hoses (26) and the flexible high-pressure hoses (17) (placed, for example, on top of the power jacks) and between the power jacks (7) and the back-flow check valves (18). A return bleeder (100) placed in the base and on the upper side of each power jack (7) leads to the gas zone above the water level inside the recirculation tank (66) beneath the turbine wheel (11) via a common bleeder return pipe (102) where appropriate back-flow check valves (101) are provided for each return bleeder (100) from the power jacks (7). A pipe connection (103) is, moreover, placed in the gas zone (24) inside the pressure-balancing tanks (23) and to the gas zone beyond the turbine wheel (11), and this is equipped with an appropriate valve (104) to regulate any gas supply from the gas zone (24) inside the pressure-balancing tanks (23) to the gas zone beyond the turbine wheel (11).

5. According to claim 1, the device for utilising ocean-wave energy is characterised by the rotatable mooring and energy-transmitting device (16) consisting of a cylindrical, rotatable mooring unit (29) equipped with external fasteners (30) to which the lower ends of anchor lines (31), comprised of a robust alloy, wire or chains, are fastened where a receptacle (32) fixed to their outer side fits into a matching receptacle (33) placed on the lower part of an external, cylindrical, non-rotatable mooring base (34). The mooring unit fits into the mooring base via a neckline (32b) that abuts against the base (34) which, in turn, is hinged to the lighter (63) by two axles (98) that are part of a hinge contraption (51) fastened to the lighter (63) in such a way that the external fastening devices (30) and the mooring base (29) can pivot vertically up and down as the anchor lines (31) move, at the same time as the mooring unit (29) is capable of rotating relative to the mooring base (34). The electrical energy from the electric generator (36) is conveyed via an electroconductive cable (35) through the centre of the cylindrical, rotatable mooring unit (29), passing first through a non-rotatable electric transmission unit (37) used to transmit electrical energy to and through the rotatable electroconductive cable on the inner side of the mooring unit (29), where the non-rotatable unit (37) consists of an external protective cap (38) fixed to the mooring base (34) with the help of, for example, suitable bolts. An intermediate thrust plate (39) ensures that the rotatable mooring unit (29) and the electroconductive cable (35) do not press up into the non-rotatable electrical transmission unit (37). Each electroconductive phase (40a) from the generator (36) is led into the external protective cap (38) via electrical insulators (41) fixed to the cap. Internal pressure springs (42) press appropriate stationary, electroconductive transmission units (43) made of, for example, carbon, against commutators (44) connected to the electroconductive phases (40b) in the electroconductive cable (35) which continues via the mooring unit (29) and is enclosed in a robust cylindrical protective shield (45) which abuts against a receptacle (46) placed on the inner side of the mooring unit (29) and against part or all of the upper part of the cylindrical mooring unit (29) and against the thrust plate (39) before ending slightly above the phase conductors (40b) which pass through holes in the shield (45). A cylindrical insulator (47) is located against the upper part of the shield (45) and on the inner side of the commutators (44), and additional insulators (48) are placed between the commutators (44), in addition to further insulators (49) located between the stationary electroconductive transmission units (43) and insulators (50) on the outer side of the commutators (44) and against the stationary electroconductive transmission units (43).

6. According to claim 1, the device for utilising ocean-wave energy is characterised by the rotatable mooring and energy-transmitting device (16) being attached to at least three anchor lines (31) which, in turn, are attached to appropriate weights (52), for example anchors (52), distributed around and away from the rotatable mooring and energy-transmitting device (16).

7. According to claim 1, the device for utilising ocean-wave energy is characterised by several power units (80) being attached to a submarine mooring net consisting of robust connecting devices (82) to which each power unit (80) is linked by connecting lines (83)—up to four lines (83) to separate connecting devices attached to the mooring net outside the middle connecting device (82) to which the lines (83) in this case are not attached—and to the fastening arrangements (30) of the mooring and energy-transmitting device (16), each connecting device (82) being kept in place by four intermediate connecting lines (84) which lie horizontally beneath the surface of the sea and pass at approximately 90° to each other out from the connecting device (82). The connecting device (82) outside the outermost of the power units (80) is connected to appropriate buoyancy buoys (86) via connecting lines (83) which are attached to the buoys on the surface, and appropriate anchor lines (87) fastened to a weight (95), or an anchor (95), on the seabed, run out from these outermost connecting devices (82). Cables (35) carrying electric current run from each power unit (80) to a moored, floating, processing lighter (89) which may also be moored to some of the buoyancy buoys (86) just beyond the plant. The electrical energy is collected here and is transmitted to land by cable or used here to produce, for example, hydrogen, methanol or ethanol from seawater by electrolysis. These products may then be conveyed to land in pipelines or suitable vessels for further processing.

8. According to claim 1, the device for utilising ocean-wave energy is characterised by having shunt pipe connections equipped with start-to-leak loaded back-flow check valves installed between the high-pressure (19) and low-pressure pipes (25).

9. According to claim 1, the device for utilising ocean-wave energy is characterised by having a computer program that processes signals from essential sensors placed inside the pressure-balancing (23) and recirculation tanks (66) to ensure that the water levels in these tanks (23, 66) always remains within their permitted upper and lower limits. Furthermore, any shortage of air in the recirculation tanks (66) is replenished with air taken from the air zone (24) in the pressure-balancing tanks (23) via a pipe or hose connection (103) equipped with an adjustable full-way valve (104) controlled by signals from the computer program, and any excess of air in the pressure-balancing tanks (23) recorded by a pressure sensor inside the tanks which is linked to the computer program is led directly to the atmosphere via a valve controlled by the computer program and attached to a pipe leading into the gas zone (24) inside the pressure-balancing tanks (23). An appropriate compressor which is directly or indirectly run from the turbine plant, and is controlled by the computer program, takes compressed air into the gas zone (24) via the same pipes when the maximum pressure in the gas zone (24) is not attained because the water level inside the pressure-balancing tanks (23) has reached its maximum permitted level in the tanks (23).

10. According to claim 1, the device for utilising ocean-wave energy is characterised by the power production on the installations being able to be monitored and regulated from an external location, for example on land, via satellites or other appropriate communication systems.

11. According to claim 2, the device for utilising ocean-wave energy is characterised by several power units (80) being capable of being interlinked using appropriate hinges (13), or perhaps intermediate girders which pass over the central units (2, 2b) aid are attached to their upper part, where the middle central unit (2b) is attached to a girder (60) which is hinged (14) to the central unit (2b) and intermediate girders which pass over the central units (2, 2b) and are attached to their upper part, where the middle central unit (2b) is attached to a girder (60) which is hinged (14) to the central unit (2b) and hinged (15) to a floating lighter (63), and the potential energy in the liquid (10) from the power jacks (7) is converted into another type of energy, and a specially designed, rotatable mooring and energy-transmitting device (16) is attached to the lighter (63) on the opposite end to where the girder (60) is placed thus ensuring that the power unit(s) (80) automatically head(s) into the wind and the ocean waves (55).

12. According to claim 2, the device for utilising ocean-wave energy is characterised by the energy-bearing, continually circulating liquid (10) being conveyed from the power jacks (7) via some flexible high-pressure hoses (17) equipped with appropriate back-flow check valves (18) which are attached to robust high-pressure pipes (19) placed on each of the central units (2), the girder (60) and the lighter (63), appropriate opening and closing valves (75) being placed at the entrances to these high-pressure pipes (19), and the liquid being conveyed between each of the central units (2) through appropriate, flexible, high-pressure hoses (21); appropriate opening and closing valves (22) are furthermore attached directly to the high-pressure pipes (19) at the entrances and exits of these high-pressure hoses (21). The liquid is thereupon conveyed to a pressure-balancing tank (23) that is partly filled with a gas (24), such as air, which is fed into the tank (23) as required, and a valve attached to the tank (23) releases air into the atmosphere as required. The liquid (10) then continues to the turbine (11), placed high on the floating lighter (63), where a mechanism controls the volume of the liquid (10) flowing through it. From the turbine, the liquid (10) is conveyed back to the power jacks (7) through appropriate, perhaps flexible, return pipes (25) with flexible pipes between the central units (2), in the same way as it is conveyed from the power jacks (7) to the turbine (11), and through flexible return hoses (26) from the return pipes (25) and the power jacks (7) that are equipped with opening and closing valves (76). Appropriate shunt hoses (73) or pipes (73) equipped with shunt opening and closing valves (74) are placed between these flexible return hoses (26) and the flexible high-pressure hoses (17) (placed, for example, on top of the power jacks) and between the power jacks (7) and the back-flow check valves (18). A return bleeder (100) placed in the base and on the upper side of each power jack (7) leads to the gas zone above the water level inside the recirculation tank (66) beneath the turbine wheel (11) via a common bleeder return pipe (102) where appropriate back-flow check valves (101) are provided for each return bleeder (100) from the power jacks (7). A pipe connection (103) is, moreover, placed in the gas zone (24) inside the pressure-balancing tanks (23) and to the gas zone beyond the turbine wheel (11), and this is equipped with an appropriate valve (104) to regulate any gas supply from the gas zone (24) inside the pressure-balancing tanks (23) to the gas zone beyond the turbine wheel (11).

13. According to claim 3, the device for utilising ocean-wave energy is characterised by the energy-bearing, continually circulating liquid (10) being conveyed from the power jacks (7) via some flexible high-pressure hoses (17) equipped with appropriate back-flow check valves (18) which are attached to robust high-pressure pipes (19) placed on each of the central units (2), the girder (60) and the lighter (63), appropriate opening and closing valves (75) being placed at the entrances to these high-pressure pipes (19), and the liquid being conveyed between each of the central units (2) through appropriate, flexible, high-pressure hoses (21); appropriate opening and closing valves (22) are furthermore attached directly to the high-pressure pipes (19) at the entrances and exits of these high-pressure hoses (21). The liquid is thereupon conveyed to a pressure-balancing tank (23) that is partly filled with a gas (24), such as air, which is fed into the tank (23) as required, and a valve attached to the tank (23) releases air into the atmosphere as required. The liquid (10) then continues to the turbine (11), placed high on the floating lighter (63), where a mechanism controls the volume of the liquid (10) flowing through it. From the turbine, the liquid (10) is conveyed back to the power jacks (7) through appropriate, perhaps flexible, return pipes (25) with flexible pipes between the central units (2), in the same way as it is conveyed from the power jacks (7) to the turbine (11), and through flexible return hoses (26) from the return pipes (25) and the power jacks (7) that are equipped with opening and closing valves (76). Appropriate shunt hoses (73) or pipes (73) equipped with shunt opening and closing valves (74) are placed between these flexible return hoses (26) and the flexible high-pressure hoses (17) (placed, for example, on top of the power jacks) and between the power jacks (7) and the back-flow check valves (18). A return bleeder (100) placed in the base and on the upper side of each power jack (7) leads to the gas zone above the water level inside the recirculation tank (66) beneath the turbine wheel (11) via a common bleeder return pipe (102) where appropriate back-flow check valves (101) are provided for each return bleeder (100) from the power jacks (7). A pipe connection (103) is, moreover, placed in the gas zone (24) inside the pressure-balancing tanks (23) and to the gas zone beyond the turbine wheel (11), and this is equipped with an appropriate valve (104) to regulate any gas supply from the gas zone (24) inside the pressure-balancing tanks (23) to the gas zone beyond the turbine wheel (11).

14. According to claim 2, the device for utilising ocean-wave energy is characterised by the rotatable mooring and energy-transmitting device (16) consisting of a cylindrical, rotatable mooring unit (29) equipped with external fasteners (30) to which the lower ends of anchor lines (31), comprised of a robust alloy, wire or chains, are fastened where a receptacle (32) fixed to their outer side fits into a matching receptacle (33) placed on the lower part of an external, cylindrical, non-rotatable mooring base (34). The mooring unit fits into the mooring base via a neckline (32b) that abuts against the base (34) which, in turn, is hinged to the lighter (63) by two axles (98) that are part of a hinge contraption (51) fastened to the lighter (63) in such a way that the external fastening devices (30) and the mooring base (29) can pivot vertically up and down as the anchor lines (31) move, at the same time as the mooring unit (29) is capable of rotating relative to the mooring base (34). The electrical energy from the electric generator (36) is conveyed via an electroconductive cable (35) through the centre of the cylindrical, rotatable mooring unit (29), passing first through a non-rotatable electric transmission unit (37) used to transmit electrical energy to and through the rotatable electroconductive cable on the inner side of the mooring unit (29), where the non-rotatable unit (37) consists of an external protective cap (38) fixed to the mooring base (34) with the help of, for example, suitable bolts. An intermediate thrust plate (39) ensures that the rotatable mooring unit (29) and the electroconductive cable (35) do not press up into the non-rotatable electrical transmission unit (37). Each electroconductive phase (40a) from the generator (36) is led into the external protective cap (38) via electrical insulators (41) fixed to the cap. Internal pressure springs (42) press appropriate stationary, electroconductive transmission units (43) made of, for example, carbon, against commutators (44) connected to the electroconductive phases (40b) in the electroconductive cable (35) which continues via the mooring unit (29) and is enclosed in a robust cylindrical protective shield (45) which abuts against a receptacle (46) placed on the inner side of the mooring unit (29) and against part or all of the upper part of the cylindrical mooring unit (29) and against the thrust plate (39) before ending slightly above the phase conductors (40b) which pass through holes in the shield (45). A cylindrical insulator (47) is located against the upper part of the shield (45) and on the inner side of the commutators (44), and additional insulators (48) are placed between the commutators (44), in addition to further insulators (49) located between the stationary electroconductive transmission units (43) and insulators (50) on the outer side of the commutators (44) and against the stationary electroconductive transmission units (43).

15. According to claim 3, the device for utilising ocean-wave energy is characterised by the rotatable mooring and energy-transmitting device (16) consisting of a cylindrical, rotatable mooring unit (29) equipped with external fasteners (30) to which the lower ends of anchor lines (31), comprised of a robust alloy, wire or chains, are fastened where a receptacle (32) fixed to their outer side fits into a matching receptacle (33) placed on the lower part of an external, cylindrical, non-rotatable mooring base (34). The mooring unit fits into the mooring base via a neckline (32b) that abuts against the base (34) which, in turn, is hinged to the lighter (63) by two axles (98) that are part of a hinge contraption (51) fastened to the lighter (63) in such a way that the external fastening devices (30) and the mooring base (29) can pivot vertically up and down as the anchor lines (31) move, at the same time as the mooring unit (29) is capable of rotating relative to the mooring base (34). The electrical energy from the electric generator (36) is conveyed via an electroconductive cable (35) through the centre of the cylindrical, rotatable mooring unit (29), passing first through a non-rotatable electric transmission unit (37) used to transmit electrical energy to and through the rotatable electroconductive cable on the inner side of the mooring unit (29), where the non-rotatable unit (37) consists of an external protective cap (38) fixed to the mooring base (34) with the help of, for example, suitable bolts. An intermediate thrust plate (39) ensures that the rotatable mooring unit (29) and the electroconductive cable (35) do not press up into the non-rotatable electrical transmission unit (37). Each electroconductive phase (40a) from the generator (36) is led into the external protective cap (38) via electrical insulators (41) fixed to the cap. Internal pressure springs (42) press appropriate stationary, electroconductive transmission units (43) made of, for example, carbon, against commutators (44) connected to the electroconductive phases (40b) in the electroconductive cable (35) which continues via the mooring unit (29) and is enclosed in a robust cylindrical protective shield (45) which abuts against a receptacle (46) placed on the inner side of the mooring unit (29) and against part or all of the upper part of the cylindrical mooring unit (29) and against the thrust plate (39) before ending slightly above the phase conductors (40b) which pass through holes in the shield (45). A cylindrical insulator (47) is located against the upper part of the shield (45) and on the inner side of the commutators (44), and additional insulators (48) are placed between the commutators (44), in addition to further insulators (49) located between the stationary electroconductive transmission units (43) and insulators (50) on the outer side of the commutators (44) and against the stationary electroconductive transmission units (43).

16. According to claim 4, the device for utilising ocean-wave energy is characterised by the rotatable mooring and energy-transmitting device (16) consisting of a cylindrical, rotatable mooring unit (29) equipped with external fasteners (30) to which the lower ends of anchor lines (31), comprised of a robust alloy, wire or chains, are fastened where a receptacle (32) fixed to their outer side fits into a matching receptacle (33) placed on the lower part of an external, cylindrical, non-rotatable mooring base (34). The mooring unit fits into the mooring base via a neckline (32b) that abuts against the base (34) which, in turn, is hinged to the lighter (63) by two axles (98) that are part of a hinge contraption (51) fastened to the lighter (63) in such a way that the external fastening devices (30) and the mooring base (29) can pivot vertically up and down as the anchor lines (31) move, at the same time as the mooring unit (29) is capable of rotating relative to the mooring base (34). The electrical energy from the electric generator (36) is conveyed via an electroconductive cable (35) through the centre of the cylindrical, rotatable mooring unit (29), passing first through a non-rotatable electric transmission unit (37) used to transmit electrical energy to and through the rotatable electroconductive cable on the inner side of the mooring unit (29), where the non-rotatable unit (37) consists of an external protective cap (38) fixed to the mooring base (34) with the help of, for example, suitable bolts. An intermediate thrust plate (39) ensures that the rotatable mooring unit (29) and the electroconductive cable (35) do not press up into the non-rotatable electrical transmission unit (37). Each electroconductive phase (40a) from the generator (36) is led into the external protective cap (38) via electrical insulators (41) fixed to the cap. Internal pressure springs (42) press appropriate stationary, electroconductive transmission units (43) made of, for example, carbon, against commutators (44) connected to the electroconductive phases (40b) in the electroconductive cable (35) which continues via the mooring unit (29) and is enclosed in a robust cylindrical protective shield (45) which abuts against a receptacle (46) placed on the inner side of the mooring unit (29) and against part or all of the upper part of the cylindrical mooring unit (29) and against the thrust plate (39) before ending slightly above the phase conductors (40b) which pass through holes in the shield (45). A cylindrical insulator (47) is located against the upper part of the shield (45) and on the inner side of the commutators (44), and additional insulators (48) are placed between the commutators (44), in addition to further insulators (49) located between the stationary electroconductive transmission units (43) and insulators (50) on the outer side of the commutators (44) and against the stationary electroconductive transmission units (43).

17. According to claim 2, the device for utilising ocean-wave energy is characterised by the rotatable mooring and energy-transmitting device (16) being attached to at least three anchor lines (31) which, in turn, are attached to appropriate weights (52), for example anchors (52), distributed around and away from the rotatable mooring and energy-transmitting device (16).

18. According to claim 3, the device for utilising ocean-wave energy is characterised by the rotatable mooring and energy-transmitting device (16) being attached to at least three anchor lines (31) which, in turn, are attached to appropriate weights (52), for example anchors (52), distributed around and away from the rotatable mooring and energy-transmitting device (16).

19. According to claim 4, the device for utilising ocean-wave energy is characterised by the rotatable mooring and energy-transmitting device (16) being attached to at least three anchor lines (31) which, in turn, are attached to appropriate weights (52), for example anchors (52), distributed around and away from the rotatable mooring and energy-transmitting device (16).

20. According to claim 5, the device for utilising ocean-wave energy is characterised by the rotatable mooring and energy-transmitting device (16) being attached to at least three anchor lines (31) which, in turn, are attached to appropriate weights (52), for example anchors (52), distributed around and away from the rotatable mooring and energy-transmitting device (16).
